(19) United States
(12) Patent Application Publication
(10) Pub. No.: US 2013/0112144 A1
(43) Pub. Date: May 9, 2013

(54) DAIRY PARLOR CURB LIGHTING SYSTEM AND METHODS

(71) Applicant: Ivanovich Wasuck, Munnsville, NY (US)

(72) Inventor: Ivanovich Wasuck, Munnsville, NY (US)

(73) Assignee: GEA FARM TECHNOLOGIES, INC., Naperville, IL (US)

(21) Appl. No.: 13/291,469

(22) Filed: Nov. 8, 2011

(51) Int. Cl. A01J 7/00; A01J 5/00

(52) U.S. Cl. 119/14.03; 119/14.18

(57) ABSTRACT

A dairy parlor light unit for mounting on or in a milking stall curb to illuminate an underside of an animal in the milking stall.

### FIELD AND BACKGROUND OF THE INVENTION

The present invention relates generally to a lighting system for a dairy parlor and more particularly to a lighting system mounted in connection with a milking stall curb.

Dairy milking parlors are inherently wet, dirty, abusive, and sometimes dark environments. Dairy animals are prepared for milking by an operator standing adjacent to the milking stall. The dairy animal is prepared for milking by wiping and massaging its teats. A milker unit is then raised up and its teat cups are attached to individual teats with vacuum that is transmitted through the milk lines and milker unit.

During the preparation process, the operator typically has relatively low light available to perform the necessary tasks overhead. Lights are useful, but the underside of the cow, where the work is done, is in a shadow of the animal's body. Further, the dairy environment's harsh and abusive conditions, as well as the tight space in which to work, make the use of lights in other locations impractical.

For example, most milking stalls include a curb to protect an operator from fluid and debris spilling from the milking stall. Lighting on the curb has not been used before for various reasons. Conventional incandescent bulbs and CFL bulbs require significant mounting envelopes and energy. To use such as system, it would be necessary to either mount them on the operator work station side of the curbing and put slots in the curb for light to pass through, or consume excessive amounts of space on the cow side of the curb to mount them. The “real estate” at the inside (cow) edge of the curb is very minimal due to the limited amount of distance between the curb and the rear legs of the cow. Stray voltage from lighting systems can also be an issue in dairy parlors, and there can be interference with cow identification systems.

Thus, there is a need to provide a light system and lighting methods for a dairy parlor milking stall that can overcome the problems described above.

### SUMMARY OF THE INVENTION

The present invention overcomes the difficulty in providing useful lights to a dairy parlor milking stall by mounting the lights on a curb that at least partially surrounds the milk stall. Curbs minimize the flow of dirt debris, manure, and other liquids from entering the operator work station. A curb light is provided that includes a housing for mounting to a dairy stall curb, a light mounted in the housing; and a power source for powering the light. The housing can be a modular component that is joined to the curb or mounted integrally therein.

The light systems of the invention can be options on new parlors, upgrades on current parlors, and upgrades on competitive parlors. The system can be used in straight pit and conventional parlors, but systems for a rotary parlor can also be produced.

When provided as a modular unit, the housing is secured to the curb using suitable fasteners. The housing can be shaped to withstand impact from dairy animals and moving equipment, as well as shed dirt.

The light can include a number of light LED bulbs mounted on a circuit board for ease of installation and replacement. The light preferably shines through a corresponding opening in the housing, and a lens or other protective device can be disposed in the opening to focus light or simply protect the light from exposure to dairy conditions.

The housing can be shaped to fit over or on to a curb of the milking stall. Preferably, the curb is disposed between the operator's work station and the dairy animal so that the light is directed away from the operator and toward the animal. Further, the housing can be mounted at an elevation that is lower than the dairy animal's udder so that the light shines substantially upward or from the side of the teats to be cleaned and attached to the milker unit.

The housing of a modular embodiment of the invention can be shaped to or have a portion that is shaped to substantially conform to the curb or even to flex over and be secured by a resilient force in the housing. The force can be applied by resilient material used to make the housing (such as stainless steel) or an additional element such as a resilient bearing member, screws, bolts, or other device that can at least partially secure the frame to the curb. Additional fasteners can be used, if desired.

The housing can also be formed integrally with the curb when the curb is constructed or retrofitted. Preferably, the curb is formed of metal or a moldable and curable material such as concrete. In these embodiments of the invention, the housing can be a simple frame or structure on which a light can be releasably mounted. The curb itself can be the housing for the curb light.

The housing is preferably secured permanently to the curb, while the light is releasably joined to the housing for simplified installation and replacement. When the housing is formed integrally with the curb, the curb has an opening through which the light can shine and a lens or protective cover is disposed in or over the opening.

Preferably, the light is connected to a power source via suitable wiring. Given the restrictive confines of a dairy parlor milking stall, the wiring is preferably integrated into or below the curb. The wiring can include a jack into which the light is releasably plugged so that replacing the light can be done quickly, safely, and reliably. The wiring can be run through a separate conduit or through a conduit formed by the curb, such as a rolled edge.

Other features and benefits will be apparent in the detailed description below.

### BRIEF DESCRIPTION OF THE DRAWINGS

FIG. 1A is a partial perspective view of one embodiment of a dairy parlor milking stall with a light system in accordance with the present invention;

FIG. 1B is a partial perspective view of an alternate embodiment of a diary stall curb light in accordance with the present invention;

FIG. 2 is a partial perspective view of a dairy parlor milking stall with a curb light in accordance with the present invention;

FIG. 3 is a perspective view of a modular curb light in accordance with the present invention;

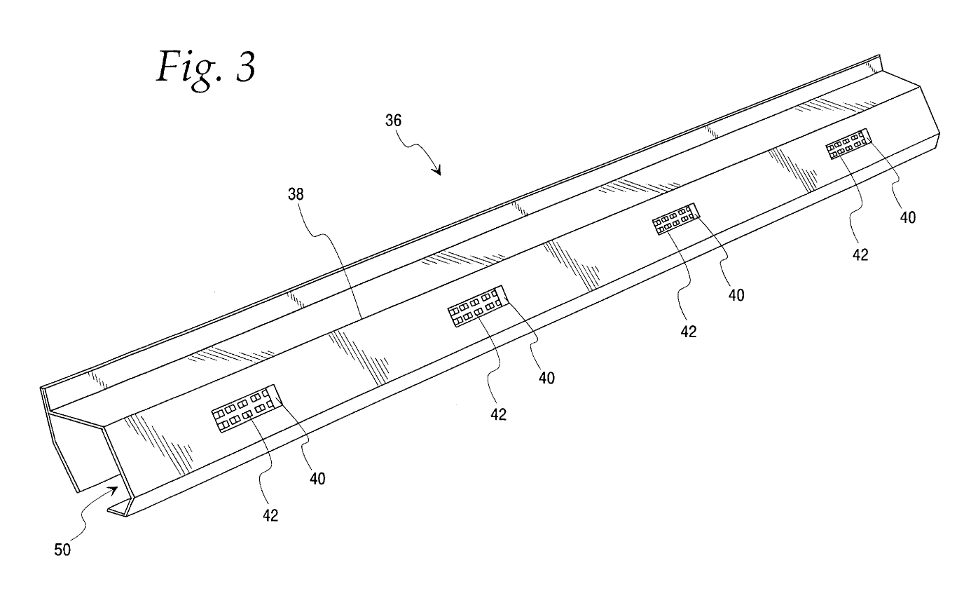

FIG. 4 is a perspective view of a modular curb light mounted on a dairy parlor milking stall curb in accordance with the present invention;

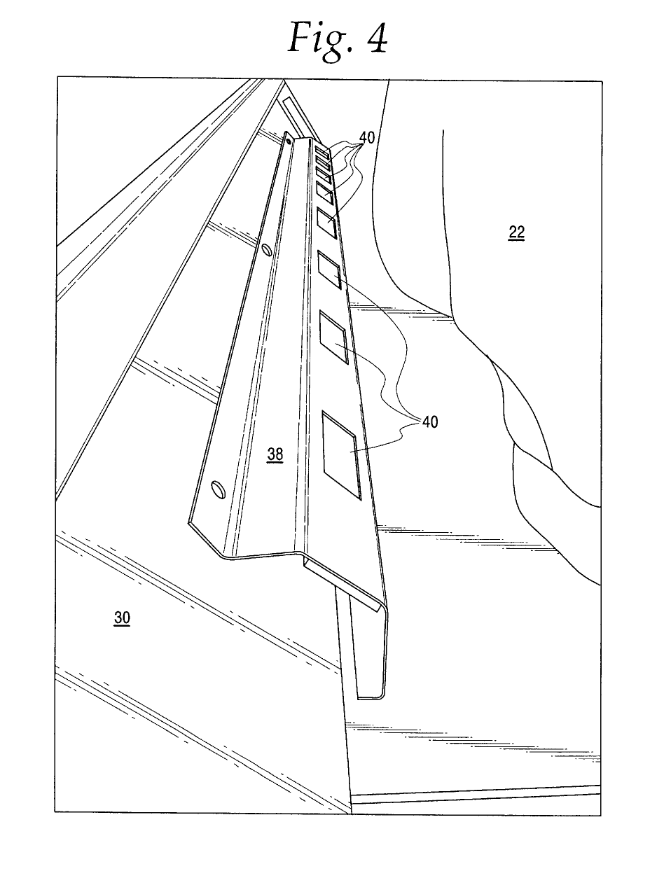

FIG. 5 is a partial from view of the modular curb light of FIG. 4;

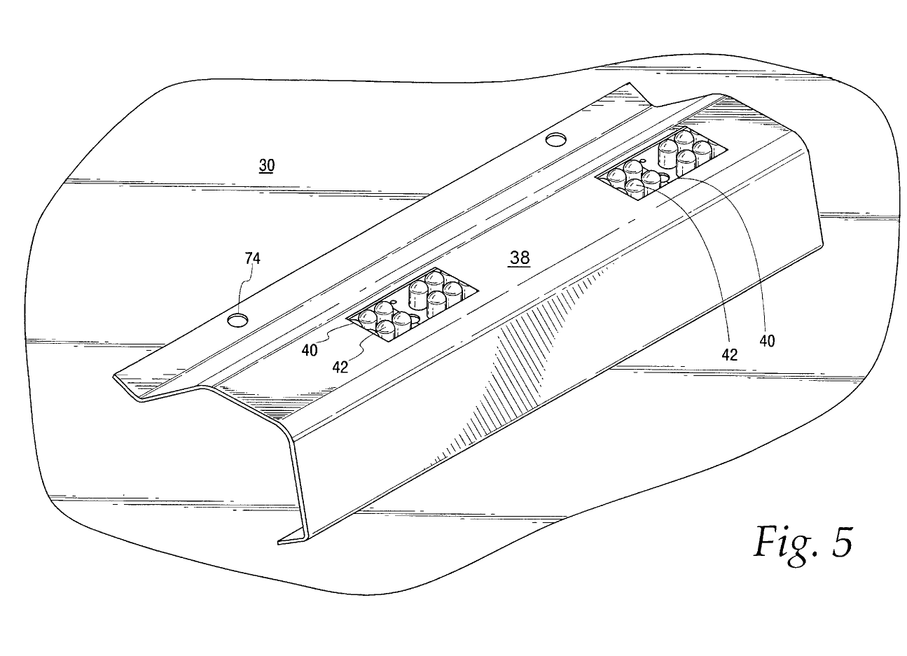

FIG. 6 is a side view of the modular curb light of FIG. 4;

FIG. 7 is a partial perspective view of a dairy parlor milking stall curb with an integrated curb light in accordance with the present invention;

FIG. 8 is the milking stall curb and integrated curb light of FIG. 7 with a protective cover over a light opening in the curb;

FIG. 9 is a rear perspective view of a curb and light in accordance with the present invention;

FIG. 10 is a perspective view of a light board in accordance with the present invention;

FIG. 11 is a side view of the light board of FIG. 10;

FIG. 12 is a schematic illustration of a wiring diagram in accordance with the present invention.

### DETAILED DESCRIPTION OF THE INVENTION

In the following detailed description, the same reference numerals will be used on the same or similar items in each of the figures.

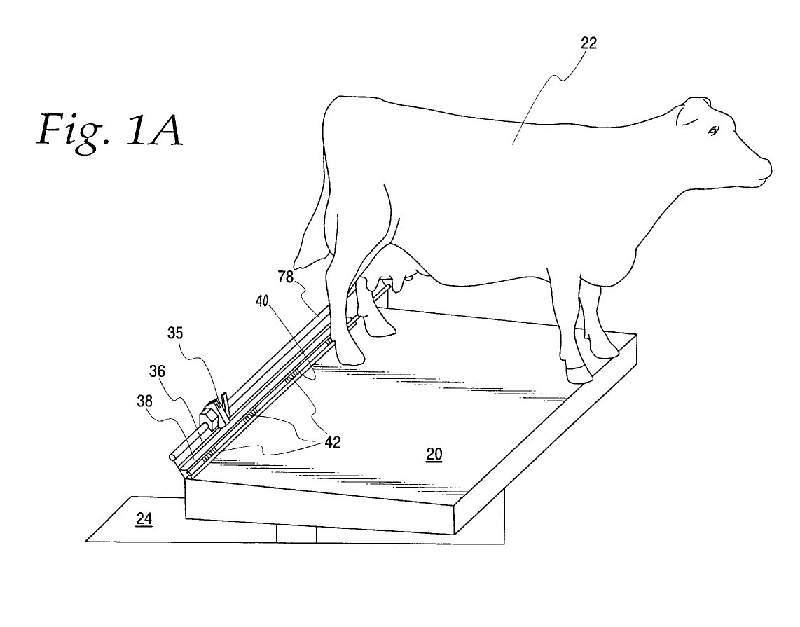

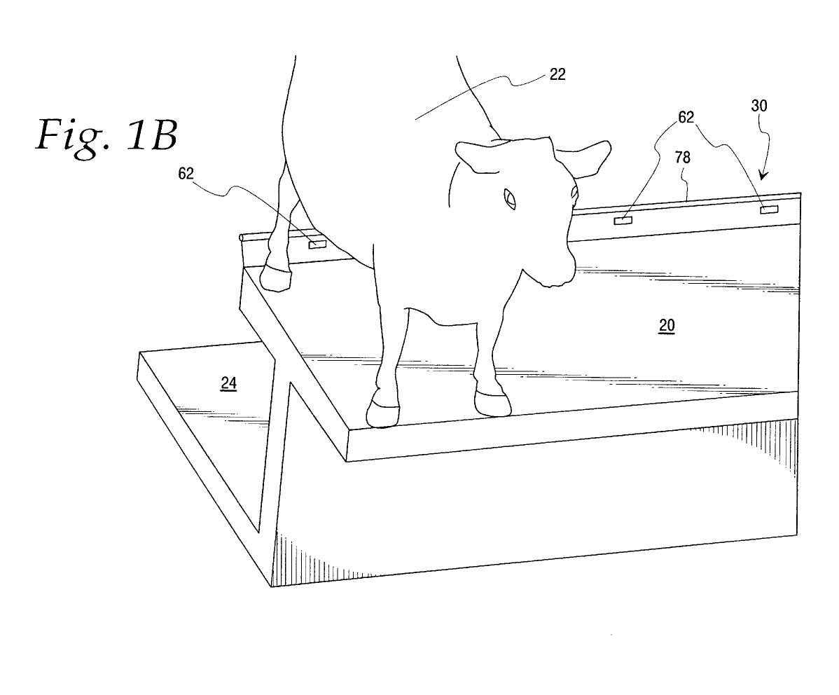

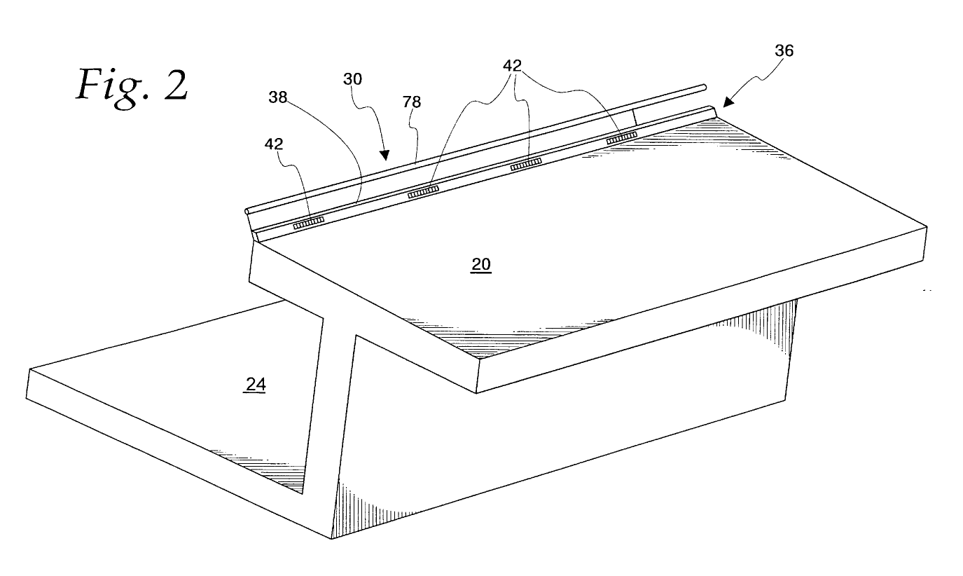

Illustrated generally in FIGS. 1A, 1B, and 2 is a dairy parlor milking stall 20 on which a dairy animal 22 can stand while being prepared for milking. The milking stall 20 can be part of a stationary parlor or a rotary parlor platform. An operator work station 24 is disposed adjacent to and preferably below the milking stall 20. An operator standing in the station 24 typically looks and reaches upward when preparing the animal 22 for milking. To protect an operator from fluids in the milking stall 20, there is provided a curb 30 that can be positioned behind or to the side of the dairy animal 22.

Any overhead lighting (not illustrated) will be shadowed by the dairy animal 22, so that the udder and teats are in a relatively dark area. Lights in or behind the operator work station 24 could interfere with the operator or be blocked by the operator, the curb 30, and an upper splash shield (not illustrated). The dairy animal's movements and the operator's position make placing lights difficult.

The curb 30 is preferably made of stainless steel, but other materials such as galvanized steel or plastic can be used that will stand up to the dairy environment. The curb 30 is typically disposed at a fixed angle relative to the milking stall 20.

Hose brackets 35 might also be present and may slide along the curb 30 for convenience. These hose brackets 35, if present, must be accessible and free to slide along the curb without interference.

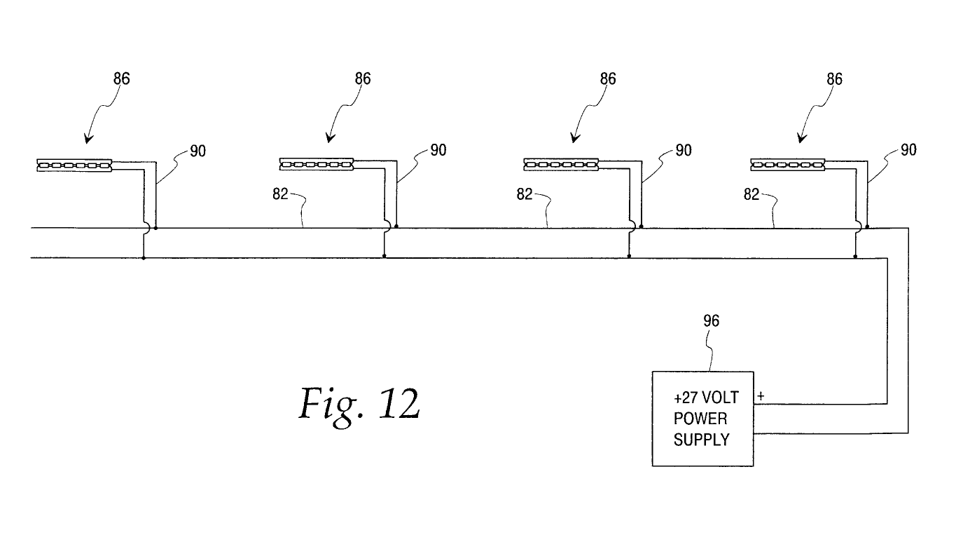

A modular curb light 36 is illustrated in FIG. 1A and includes a housing 38, a light opening 40, a light 42, and appropriate wiring to supply power (see FIG. 12). The housing 38 is preferably made of 16 gauge stainless steel but could be any material such as galvanized steel or plastic. The housing 38 is mounted on the curb 30 using connectors 46, such as brackets and screws as illustrated, but other connectors such as bolts and welds are within the scope of the present invention. The shape of the housing 38 can be set at a desired angle for the light 42 to shine onto the animal or the light 42 can be mounted on a bracket that sets the angle. The angle can be adjustable using and adjustable housing 38 or other mechanism.

The housing 38 is preferably very “low-profile” so as not to protrude into the milking stall 20. No welding is required, but can be used, if desired. The housing 38 preferably defines a chamber 50 in which the light 42 is disposed. The chamber 50 can be completely defined by the housing 38 or the housing 38 and the curb 30 can cooperate to define the chamber 50. The chamber 50 can also be partially open to ventilate heat and fluids.

The housing 38 can also be shaped or have a portion that is shaped to substantially correspond to the shape of the curb 30 so that the housing fits over the curb 30 in a mating relationship, such as a “snap fit.”

The housing 38 defines at least one light opening 40, or in the case of the illustrated embodiment, a number of openings 40. The opening 40 can be of any shape and size, but it is preferable to provide a number of openings that are spaced apart to maintain the structural integrity of the housing 38.

Disposed in the housing chamber 50 and aligned with each of the openings 40 is a corresponding light 42 that can include one or more bulbs 54. The lights 42 are preferably LED lights and each can have a directional shape to alight an object at a predetermined position and distance. In addition to or in the alternative, a light cover 58 can be mounted over a corresponding light 42 to direct light in a desired direction and focus. A heat sink can be used if the number and type of light generates excessive heat.

The light cover 58 can be any desired color of translucent material, and be mounted over, partially in, completely in, or below the light opening 40. The light cover 58 can project outwardly, but is preferably flush mounted to avoid accumulating dirt and debris, and for convenient cleaning.

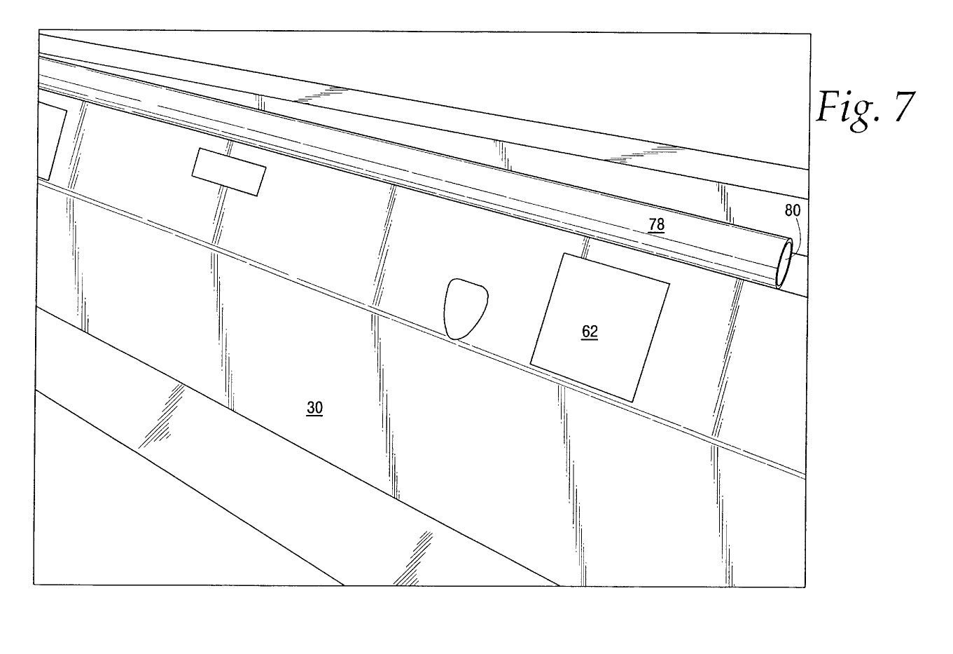

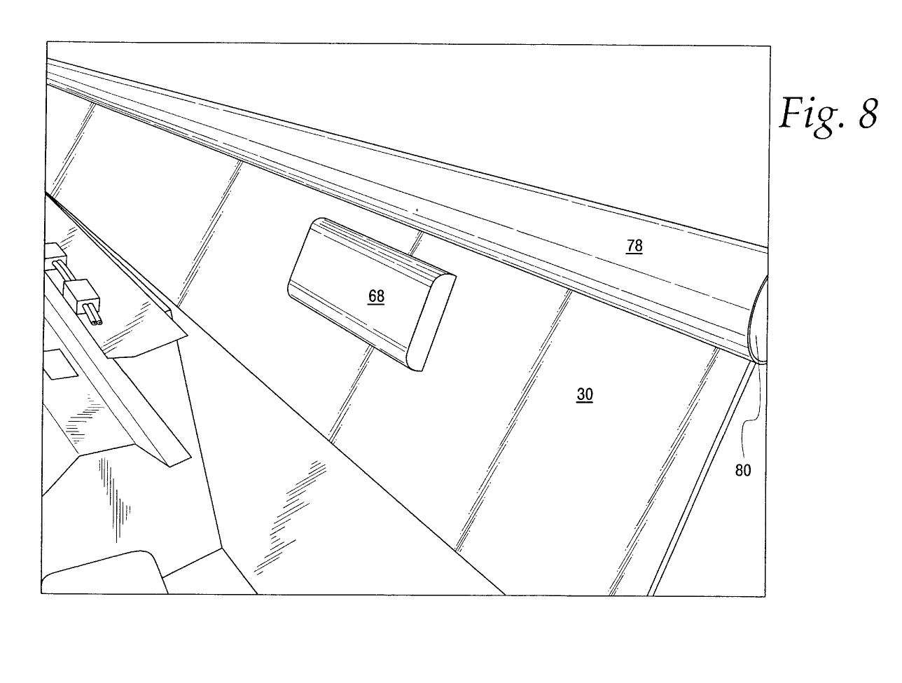

Illustrated in FIGS. 1B, and 7 to 9 is a second embodiment of curb light 60 in accordance with the present invention. In this embodiment, the curb 30 forms at least a portion of the housing 38 and defines a number of light openings 62. Corresponding lights 66 are joined to the curb 60 and aligned with a corresponding light opening 62. The lights 66 can be identical or similar to the lights 42 described above, and can be mounted on light boards like those described above or any suitable board, frame, or other device. A light cover 68 is secured to the curb using appropriate bolts or screws 74.

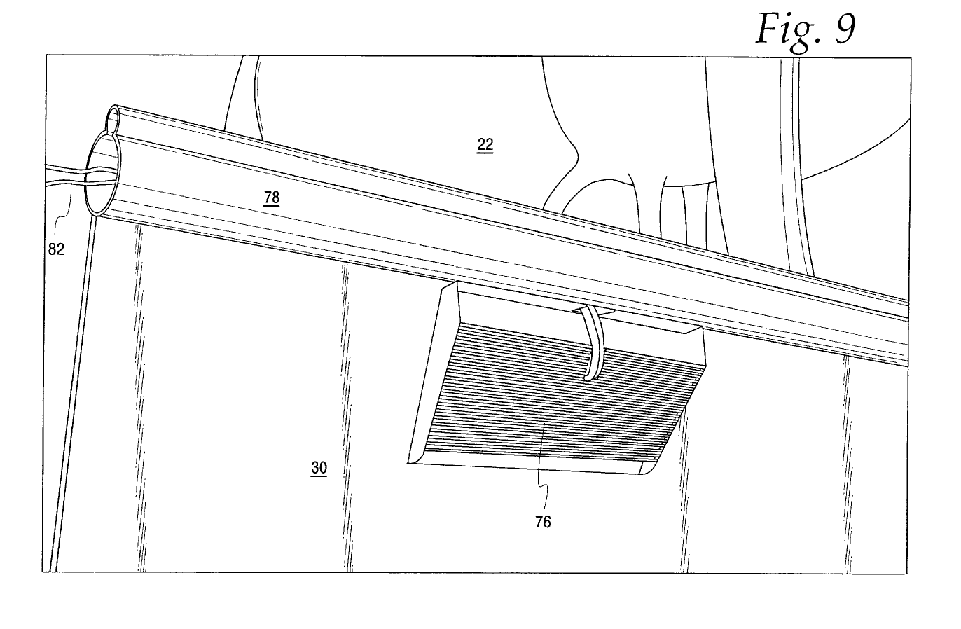

FIG. 9 illustrates the back of the curb 60, which is the view seen by an operator. A light frame 76 is mounted on the curb 60 using any suitable connector type, but the housing 38 can also be used.

As illustrated, the curb 60 includes a rolled upper edge 78 that defines a conduit 80 through which wires 82 can extend to bring power to the light 66. Alternatively, or in addition to the wire 82, a battery (not illustrated) can be used to power the lights 42 and 66.

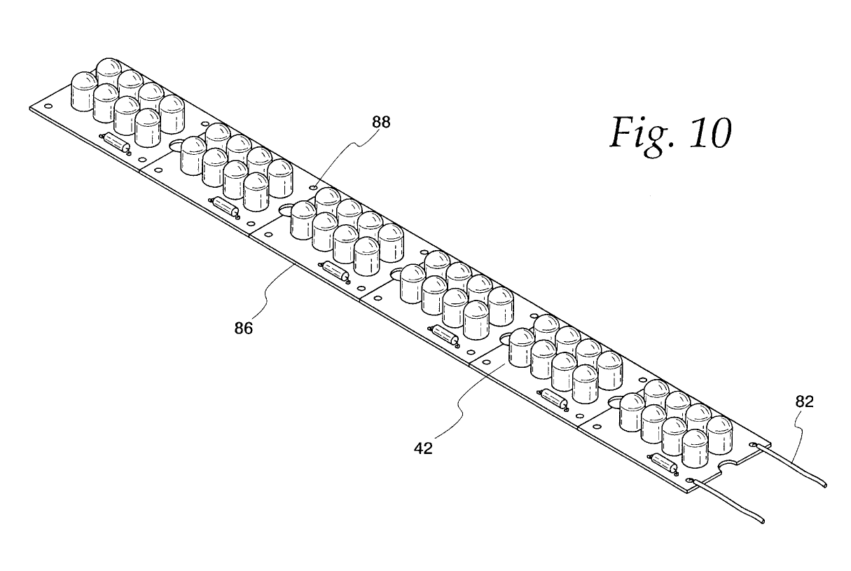

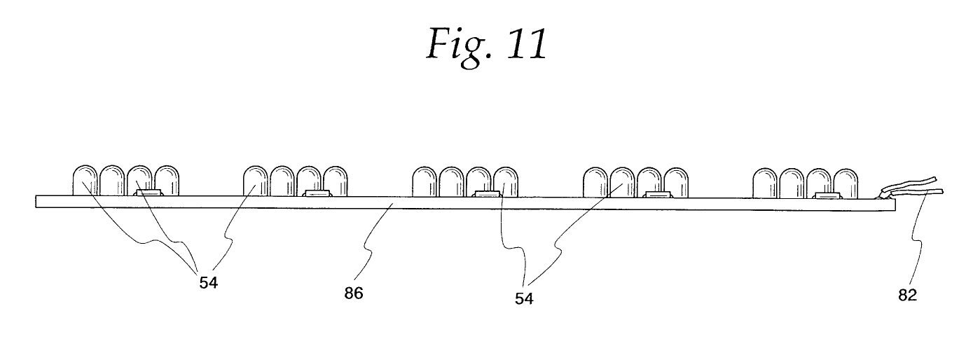

FIGS. 10 and 11 illustrate a light board 86 in accordance with the present invention. The light board 86 can be any size or shape and is preferably used to support light bulbs and related circuitry. In the embodiment of FIG. 1A, for example, the light board 86 will have the properties described below, but the embodiment of FIG. 1B preferably uses a smaller board. The light board 86 is used for a single milking stall, but it can be sized and shaped to illuminate more than one milking stall. The light board 86 is generally rectangular, as illustrated, but other types, shapes, styles, and arrangements of light can be used in the present invention. The light board 86 is preferably assembled in nine foot sections and includes connectors to fasten to other light boards or the housing 38.

The light bulbs 54 are preferably LEDs because they have an extremely long life expectancy (50,000 hours), operate on a low voltage, and with a modular design (FIG. 1A) a single cow can be illuminated. The light board 86 preferably has forty-eight bulbs, but the number can vary to accommodate particular installations. Due to the extreme environmental conditions in a milking parlor, the lights 42, 66 are exposed to extremes of water, chemicals and temperatures, so the light boards 86 preferably have a conformal coating for environmental protection. With this coating, LED lights can be submersed in water and function, unlike conventional lighting.

Another significant issue with electricity in a milking parlor is the increased risk of stray voltage, and the interference with current radio frequency identification systems. Since LEDs are using low voltage direct current (DC), there will be no issues with stray voltage. The use of DC also eliminates the interference with dairy parlor and cow identification radio frequency systems. Currently the most common type of parlor lighting is fluorescent, which has an electronic ballast that can cause interference issues with the radio frequency systems used in the dairy parlor.

The light board 86 illustrated has disposed thereon a number of light bulbs 54 arranged in a grid shape to substantially correspond to the size and shape of a corresponding curb light opening 40, 62. The light board 86 preferably includes appropriate holes 88 through which connectors can extend or the light board 86 can be connected to a housing using any type of releasable connector for simple installment and replacement.

Appropriate wiring 90 is provided for connection to a power source 96 (see FIG. 12). The wires 90 extend along and preferably beneath a curb 30 or 60, for example. Suitable protection for the wires 90 is provided, such as the rolled upper edge 78 of the curb 60 described above. Other types of conduits can be used.

Preferably, the lights 42, 66 and/or light boards 86 are connected to the wires 90 with releaseable or quick-release plugs for quick replacement without significant interference with dairy operations. The light boards 86 preferably have circuitry incorporated so that a separate wired circuit to each light is unnecessary.

As stated above, LED lights are preferred. More preferably, LED lights are round, through hole type, cool white 15k temp, which gives a clear and white light, not a yellowish hue like hotter lights. A viewing angle of 15 degrees reduces the chance of glare into an operator's eyes, and gives a tight and focused pattern.

Luminous intensity, mcd 32900-39500 is preferred. Generally, there is no heat sink required with this type of light. Surface mount LEDs typically require a substantial heat sink surface to dissipate heat, which adds costs and reduces longevity of the LED. So it is not preferred, but it is possible to use surface mount LEDs within the scope of the invention.

A cleaning system for the LED enclosures or light covers can also be provided, and can include an automated scraper on tracks like the hose mount brackets 35 described above, curb spray nozzles, or deck flush nozzles with a broad spray pattern, for example. The light cover 68 is preferably a plastic such as Lexan or Grilamid (available from Grilamid EMS CHEMIE, Inc., at 2060 Corporate Way, P.O. Box 1717, Sumter, S.C. 29151) or some other scratch-resistant plastic.

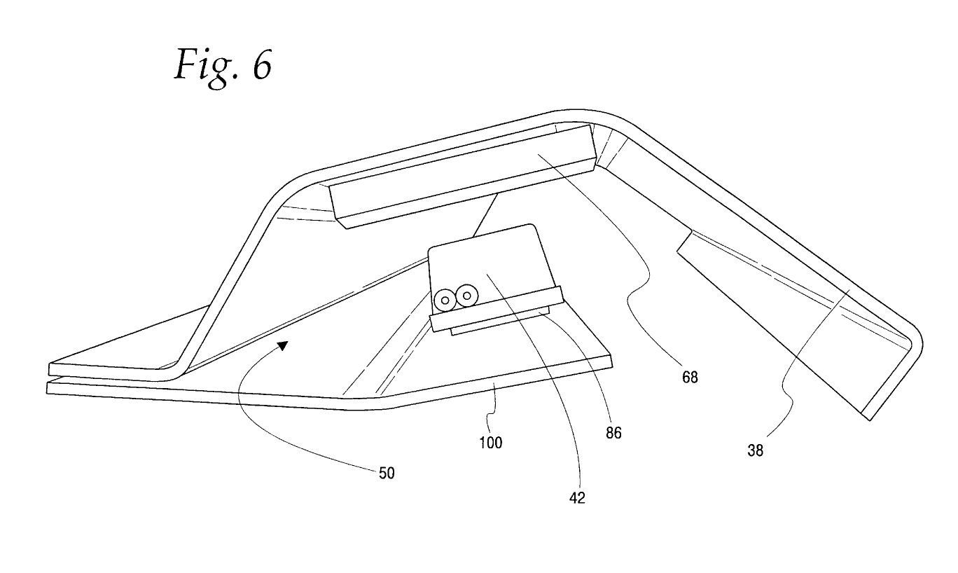

The angle of the curb 30 or the housing 38 may or may not be at an optimal angle for directing light. If not, a mounting strip 100 can be used to support the lights 42, 66 at an optimum angle. The mounting strip 100 can be formed integrally with the housing 38, as illustrated in FIG. 6, or the mounting strip 100 can be added in some other way. When formed integrally as in FIG. 6, the mounting strip 100 can be bent to a desired angle. The mounting strip 100 is preferably stainless steel of a minimum of 18 ga. to allow some flexibility in the mounting angle and to support the light boards 86. There can also be an adjustable mounting strip that includes a heat sink for the light boards to suit different applications.

As seen in FIG. 6, the light boards 86 are preferably attached to the mounting strip 100 and are spaced apart from the light cover 68 within the chamber 50 to prevent electrical contact and provide space for dissipating heat from the light 42, 66. There can also be a non-conductive material attached to the bottom or other sides of the light boards 86 for electrical insulation.

The light board 86 and other parts can be assembled with the housing 38 using any suitable fastener, such as a PEM fastener available from Penn Engineering, 5190 Old Easton Rd., Danboro, Pa. 18916.

The foregoing detailed description is provided for clearness of understanding and no unnecessary limitations therefrom should be read into the following claims.

1. A light unit for a dairy parlor milking stall comprising:
a housing defining a light opening directed away from a milking stall curb;
a light joined to the housing and aligned with the light opening to shine away from the milking stall curb and toward a dairy animal in the milking stall; and
a power source connection for the light.

2. The light unit of claim 1, wherein the housing is a modular unit for connection to the milking stall curb.

3. The light unit of claim 1, wherein the housing is a portion of the milking stall curb.

4. The light unit of claim 1, wherein the power source connection is a releasable plug connector.

5. The light unit of claim 1, and further comprising:
a light cover disposed over the light opening.

6. The light unit of claim 1, and further comprising:
a light cover disposed at least partially in the light opening.

7. A curb for a dairy parlor milking stall, the curb comprising:
a light opening;
a light aligned with the light opening; and
a power source connection for the light.

8. The curb of claim 7, and further comprising:
a rolled edge defining a conduit; and
wires disposed in the conduit, for connection to the power source connection and a power source.
